(19) United States
(12) Patent Application Publication
(10) Pub. No.: US 2026/0019287 A1
(43) Pub. Date: Jan. 15, 2026

(54) CROSS-CHAIN INTEROPERABILITY PROTOCOL

(71) Applicant: SmartContract Chainlink Limited SEZC, Grand Cayman (KY)

(72) Inventors: Lorenz Breidenbach, Zug (CH); Ben Chan, Grand Cayman (KY); Steve Ellis, Grand Cayman (KY); Ari Juels, Grand Cayman (KY); Kostis Karantias, Grand Cayman (KY); Rens Rooimans, Grand Cayman (KY); Connor Stein, Grand Cayman (KY)

(73) Assignee: SmartContract Chainlink Limited SEZC, Grand Cayman (KY)

(21) Appl. No.: 19/267,524

(22) Filed: Jul. 12, 2025

Related U.S. Application Data
(60) Provisional application No. 63/670,376, filed on Jul. 12, 2024.
(60) Provisional application No. 63/672,192, filed on Jul. 16, 2024.
(60) Provisional application No. 63/842,290, filed on Jul. 11, 2025.
(60) Provisional application No. 63/842,314, filed on Jul. 11, 2025.

(51) Int. Cl. H04L 9/00

(52) U.S. Cl. CPC H04L 9/50

(57) ABSTRACT

Systems, devices, and methods for cross-chain interoperability are disclosed for transferring cross-chain messages from a source chain to a destination chain. In this manner, transfer of information and/or assets between blockchains is facilitated, leading to improved functionality of each respective chain.

### CROSS-REFERENCE TO RELATED APPLICATIONS

This application claims priority to and the benefit of: (i) U.S. Provisional Patent Application No. 63/670,376 filed Jul. 12, 2024 and entitled “CROSS-CHAIN INTEROPERABILITY PROTOCOL,” (ii) U.S. Provisional Patent Application No. 63/672,192 filed Jul. 16, 2024 and entitled “SYSTEMS AND METHODS FOR RISK MANAGEMENT NETWORKS,” (iii) U.S. Provisional Patent Application No. 63/842,290 filed Jul. 11, 2025 and entitled “CROSS-CHAIN INTEROPERABILITY PROTOCOL,” and (iv) U.S. Provisional Patent Application No. 63/842,314 filed Jul. 11, 2025 and entitled “SYSTEMS AND METHODS FOR RISK MANAGEMENT NETWORKS.” The foregoing applications are hereby incorporated by reference in their entirety for all purposes, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

This disclosure is in the field of distributed systems, and in particular the field of transferring data using blockchain and distributed network computing.

### BACKGROUND

Prior approaches for processing data using a blockchain system have suffered from various limitations, for example limitations related to interoperability and efficiency of transfer of data or information across multiple blockchains. As the number of blockchains grows, people and applications are looking for ways to best make use of new chains and their features. There is a need for programs which transfer data across multiple blockchains and interoperability among systems. Accordingly, systems and methods offering improvements thereto remain highly desirable.

### SUMMARY

Cross-chain interoperability devices, systems, and methods are disclosed herein. In an exemplary embodiment, one or more processors configured by machine-readable instructions to send, by a sender, a cross-chain message from a source chain, the cross-chain message comprising a receiver address, and a message data; process, by a cross-chain processing system, the cross-chain message; and receive, by a receiver corresponding with the receiver address, the delivered cross-chain message to a destination chain, the delivered cross-chain message comprising the message data.

The cross-chain interoperability devices, systems and methods may further comprise an off-chain processing system comprising off chain reporting. The cross-chain interoperability devices, systems and methods may further comprise wherein the cross-chain message is sent from the source chain to the destination chain, by a router. The cross-chain interoperability devices, systems and methods may further comprise wherein the fee token is received by a token pool, and one or more nodes of the cross-chain interoperability device may receive the fee token from the token pool. The cross-chain interoperability devices, systems and methods may further comprise wherein the cross-chain processing system may correspond to the destination chain.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The accompanying drawings are included to provide a further understanding of the present disclosure and are incorporated in, and constitute a part of, this specification, illustrate various exemplary embodiments, and together with the description, serve to explain exemplary principles of the disclosure.

FIG. 1 illustrates a cross-chain interoperability protocol system, in accordance with various exemplary embodiments;

FIG. 2 illustrates a blockchain system having a cross-chain interoperability protocol system and a risk management network, in accordance with various exemplary embodiments;

FIG. 3 illustrates a blockchain system having a cross-chain interoperability protocol system comprising a reports repository, in accordance with various exemplary embodiments; and

FIG. 4 illustrates a method of cross-chain interoperability, in accordance with various exemplary embodiments.

### DETAILED DESCRIPTION

The detailed description of various exemplary embodiments herein makes reference to the accompanying drawings, which show various exemplary embodiments by way of illustration. While these various exemplary embodiments are described in sufficient detail to enable those skilled in the art to practice the disclosure, it should be understood that other embodiments may be realized and that structural, logical, and/or similar changes may be made without departing from the spirit and scope of the disclosure. Thus, the detailed description herein is presented for purposes of illustration and not of limitation.

For example, steps recited in any of the method or process descriptions may be executed in any suitable order and are not necessarily limited to the order presented. Furthermore, any reference to singular may include plural embodiments, and any reference to more than one component or step may include a singular embodiment or step.

This disclosure relates generally to systems, devices and method for cross-chain interoperability. In various exemplary embodiments, the connection across multiple blockchains may be referred to as a “bridge.” When transferring or transacting across bridges there is a need to improve security. Prior designs failed to properly secure data transmitted across multiple blockchains. In various exemplary embodiments, the cross-chain operability system comprises secure security critical structure and code. For example, the cross-chain operability systems disclosed herein may include agreeing on a source chain, then executing on a destination chain, which encourages stronger security.

In various exemplary embodiments, the cross-chain interoperability system may improve the billing structure as the transfer may only require payment on the source chain for execution on the destination chain. Further, in various exemplary embodiments, an off chain estimation of the fee token is not required, which also simplifies the process and adds to security. In various exemplary embodiments, onchain quoting allows for purely onchain applications that don't require an associated offchain component. Utilizing onchain applications allows the end user to pay the transaction and the decentralized application (dapp) to remains autonomous.

In various exemplary embodiments, the cross-chain interoperability protocol comprises a user interface which token issuers can list bridgeable tokens. This facilitates fairly unique composability between dapps and token issuers.

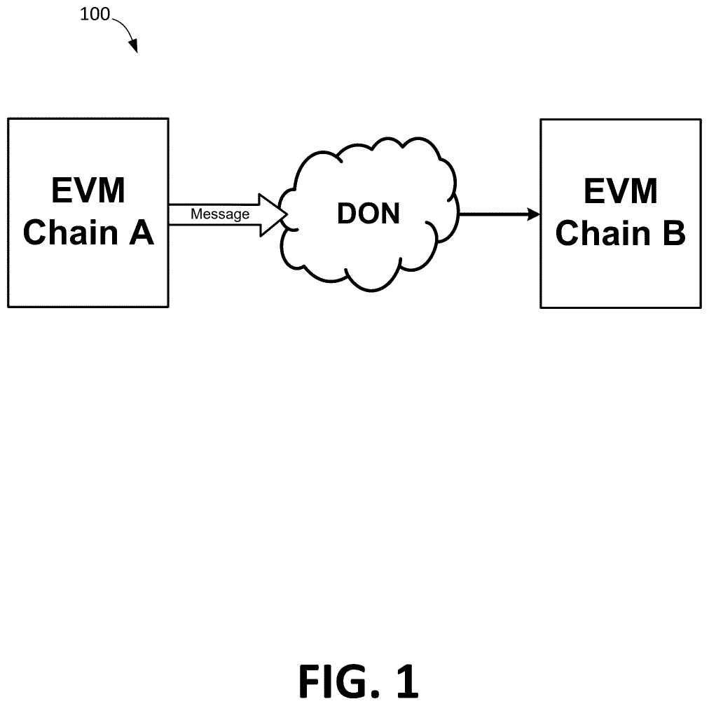

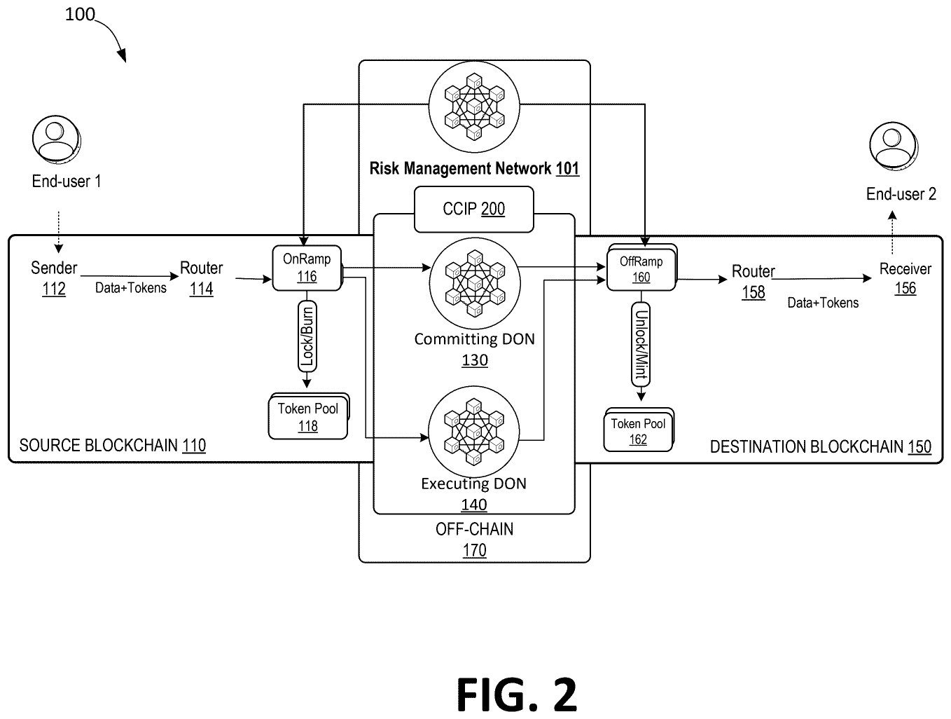

With reference now to FIGS. 1 and 2, systems, devices and methods for cross-chain interoperability, in accordance with various embodiments, are shown. In various exemplary embodiments, systems, devices and methods for cross-chain interoperability may utilize a Cross-Chain Interoperability Protocol (CCIP) for implementing capabilities and/or principles discussed herein. In various exemplary embodiments, a cross-chain interoperability system 200 may provide a universal, open standard for developers to build secure services and applications that can send messages, transfer tokens, and initiate actions across multiple blockchains.

In various exemplary embodiments, a cross-chain interoperability system may utilize a cross-chain message. The cross-chain message may be a message sent from a source blockchain to a destination blockchain. The cross-chain interoperability system may comprise a sender and a receiver. The cross-chain interoperability system may comprise a sender of a source blockchain and a receiver of a destination blockchain. In various exemplary embodiments, the term “chain” may be used in reference to a blockchain, or suitable chain of data recorded in blocks. In various exemplary embodiments, the cross-chain message may comprise a receiver address, a message data, a token, and/or a fee token. The receiver address may comprise the address of the receiver on the destination chain 150. The message data may comprise bytes of data being sent to the receiver. The token may comprise token amounts and/or type to be sent to a blockchain. For example, the token may, in various exemplary embodiments, comprise a token such as “ERC20” tokens to be sent to Ethereum Virtual Machine (EVM) source chains, or any suitable crypto currency compatible with a blockchain. The fee token may comprise the “feeToken”, i.e., the token to be used for CCIP fee payment.

With reference to FIG. 1, a CCIP system 100 is shown in accordance with various embodiments. The system may comprise a source blockchain, such as EVM Chain A and a destination blockchain, such as EVM Chain B. In various exemplary embodiments, a Decentralized Oracle Network (DON) may receive a message, such as a cross-chain message, from the EVM Chain A and then send a signal, message or cross-chain message to EVM Chain B. It can be appreciated that CCIP system 100 may be configured to receive a message from various types of source blockchains, and deliver a message to various destination blockchains, as described in more detail herein. The CCIP system 100 may be interoperable with various source blockchains and destination blockchain.

With reference to FIG. 2, a CCIP system 100 is shown in accordance with various embodiments. The CCIP system 100 may comprise a CCIP 200, which is in communication with a source blockchain 110 and a destination blockchain 150. The CCIP 200 may comprise one or more DONs, such as committing DON 130 and/or executing DON 140.

Exemplary systems disclosed herein may comprise a messaging interface that may support various delivery features including trustlessness, client validation, staking, and/or transfer of multiple transactions in a single transaction. The system may allow for cross-chain messages to be sent from a source blockchain to a destination blockchain, wherein the system may also comprise off-chain computation on a distributed network. The system may transfer the cross-chain message from the source chain to the destination and ensure that the message is not manipulated, the system properly pays other nodes in the network, and the correct information is sent to the receiver. Further, the system, through the described embodiments, may provide quick and secure delivery of cross-chain messages. The system may allow for lower costs due to the individual transaction that occurs. The system may be configured to automatically retry where a timeout or other issue occurs.

In various exemplary embodiments, the system 100 may comprise a router, such as router 114 of the source blockchain 110, and/or router 158 of the destination blockchain 150. The system 100 may further comprise a bridge, a processing node, and/or a billing component. The router may also be referred to as a router interface when referring to the interface of the router. The router may also be referred to as a router contract. The router contract may comprise a single address for routing requests to the appropriate bridge contract for each chain. The router contract may comprise a single address to receive messages from so that the messages do not need to be authenticated. A bridge contract may be configured to send information including the cross-chain message to a destination chain 150. The bridge contract may be configured to receive information including the cross-chain message from the source chain 110. The processing node may include a distributed node or singular node comprising off chain processing or off chain reporting (“OCR”). The off-chain reporting by the process node may comprise a network of nodes for agreeing on and delivering the cross-chain message. The billing component may comprise systems for ensuring the that proper payments have been made when transaction across-chains occur. In various exemplary embodiments, each bridge contract may comprise billing components. The billing components may be configurable per bridge. The system may comprise components and protocols for monitoring. For example, the system may monitor by logging of events, alerting of issues, and exposing events to users.

In various exemplary embodiments, a cross-chain message may be sent with one or more steps. For example, a router may receive the cross-chain message from the user on the source blockchain 110 to deliver on a destination blockchain 150. In various exemplary embodiments, a DON, such as committing DON 130 and/or executing DON 140, may ensure that messages from the on-ramp router (OnRampRouter) are delivered to the intended off ramp router (OffRampRouter). In various exemplary embodiments, the router may deliver the cross-chain message to the intended receiver on the destination blockchain 150.

In various exemplary embodiments, a user 1 or sender 112 may initiate a cross-chain message. For example, a decentralized network, such as a d-app may comprise a user 1 which initiates CCIP send. In various exemplary embodiments, a sender 112 (source chain d-app or user) may send a cross-chain message with CCIP 200. In various exemplary embodiments, for each token in the cross-chain message, the sender 112 may approve at least the amount of the token to be sent to the router 114. For example, the sender 112 may send a specified amount of tokens to the receiver. The sender 112 may not need to approve the token amount for every CCIP send or transfer of a cross-chain message in the cross-chain interoperability system 100. The sender 112 may approve some or all of the tokens being sent to the router 114. For example, an infinite approval for the tokens of interest to the router 114 is possible and recommended in order to avoid extra costs for every send. In various exemplary embodiments, the sender 112 may provide the cross-chain message including the destination chain 150. For example, the sender 112 may call an exemplary function ccipSend providing the message they wish to send along with their desired destination chain 150.

In various exemplary embodiments, the cross-chain interoperability system 100 may provide steps for processing on the source chain 110. For example, the cross-chain interoperability system may receive the cross-chain message and destination chain 150 information from the sender 112 and process on the source chain 110 based on the cross-chain message and destination chain 150. In various exemplary embodiments, the cross-chain interoperability system 100 may call one or more functions for processing on the source chain 110. For example, the cross-chain interoperability system 100 may use an exemplary function OnRampRouter, such as OnRamp 116 and/or router 114, to collect payment for sending the message. The cross-chain interoperability system 100 may lock the rest of the tokens to their corresponding TokenPools. The cross-chain interoperability system may sequence and emit the final message. The cross-chain interoperability system 100 may process on the source chain 110 based on the call to the router 114. For example, the cross-chain interoperability system 100 may check the message for syntactic validity. The cross-chain interoperability system 100 may make sure the destination chain 150 is supported. The cross-chain interoperability system 100 may make sure all tokens are supported for the particular destination chain 150. The cross-chain interoperability system 100 may collect a fee associated with the cross-chain message. The cross-chain interoperability system 100 may ensure that the amount of tokens sent is within rate limits, for each token included in a message. The cross-chain interoperability system 100 may send the token to its corresponding token pool 118 and/or token pool 162, if the tokens are not appropriately approved to the router 114, 158 this will fail. The cross-chain interoperability system 100 may lock and/or burn the token in the token pool. The cross-chain interoperability system may sequence the message with a sequence number based on the source chain 110, destination chain 150, and/or router. The cross-chain interoperability system 100 may emit an event containing the sequenced message. The event may be an action or command that triggers an action, such as an event-based trigger. The event containing the sequenced message may trigger the DON or any suitable distributed network to process a new cross-chain message. The DON may comprise a committing DON 130, an executing DON 140 and/or other suitable DONs or distributed networks.

In various exemplary embodiments, the cross-chain interoperability system may comprise a DON. The DON may facilitate the CCIP of the cross-chain interoperability system. The DON may facilitate the CCIP of the cross-chain interoperability system with a relaying DON and/or an execution DON, for example. The relaying DON may be responsible for notifying the destination chain 150 of messages that have been sent on a source chain 110. The DON may facilitate each relaying DON, which may correspond to a source chain 110 and destination chain 150 pair. In various exemplary embodiments, an execution DON 140 may be responsible for delivering the cross-chain message to the final receiver. In various exemplary embodiments, an execution DON 140 may correspond to the OnRamp 116 and OffRamp 160 pair.

In various exemplary embodiments, the system 110 may comprise one or more DONs, also referred to as cross-chain processing systems 100, running in parallel. In various exemplary embodiments, each cross-chain processing system may correspond to a specific destination blockchain. The cross-chain processing system 100 may be configured to send transactions to the destination chain 150. The cross-chain interoperability system may determine the cross-chain processing system to send a cross-chain message to a destination chain 150. The cross-chain processing system may specify the source chain 110 and the router address when processing. As mentioned, the source chain 110 is the blockchain that receives transactions from the system. The router address is the address containing the router contract to read from. In various exemplary embodiments, the router may send a cross-chain message to a destination chain 150, which may include the destination chain identification, the destination chain address, and a message.

In various exemplary embodiments, the cross-chain interoperability system may process on the destination chain 150. The cross-chain interoperability system may execute DON functions off-chain and deliver the cross-chain message to the destination chain 150. The cross-chain message which is delivered to the destination chain 150 may be referred to as a delivered cross-chain message. The cross-chain interoperability system may execute DON functions internally. The cross-chain interoperability system may execute and/or process a cross-chain message on the destination chain 150. The cross-chain interoperability system may check the message for syntactic validity. For example, the cross-chain interoperability system may check the cross-chain message for validity by determining if the message is coming from a supported source chain 110. The cross-chain interoperability system may determine if the token included in the cross-chain message is supported by the system. The cross-chain interoperability system may unlock the tokens. The cross-chain interoperability system may further deliver the tokens and message to the receiver. The cross-chain interoperability system may determine if the cross-chain message was successfully delivered to the destination chain 150 and/or the receiver. The cross-chain interoperability system may identify where the cross-chain message was not successfully delivered to the destination chain 150. The cross-chain interoperability system may determine the cross-chain message was not delivered, and the system may retry executing the cross-chain message.

In various exemplary embodiments, the cross-chain interoperability system may comprise token pools. The token pools may be used for facilitating transfer of cross-chain messages. The token pools may operate differently for various tokens (i.e., Ethereum, Avalanche, USDC, USDT, etc.). In various exemplary embodiments, each token may comprise its own token pool. The token pools may comprise an abstraction layer over ERC20 tokens to facilitate OnRamp and OffRamp token-related operations. In various exemplary embodiments, a token pool may be configured to lock or burn at a source blockchain. For example, the cross-chain interoperability system may signal to the Token Pool that an amount of tokens have been sent to it and will be part of a soon-to-be-sent cross-chain message using an exemplary function LockOrBurn(unit256 amount, address originalSender). In various exemplary embodiments, a token pool may be configured to release or mint at a destination blockchain. For example, the system may signal to the token pool that an incoming cross-chain message is being processed and as part of it an amount of tokens should be given to receiver using the function releaseOrMint(address receiver, unit256 amount).

In various exemplary embodiments, the system may use one or more types of token pools, such as token pool 118, token pool 162 and/or other token pools. For example, token pools may include native token pools and/or wrapped token pools. The native token pool may be configured to control a token which is native to its chain (e.g., LINK on Ethereum). The LockOrBurn function may result in no action because the token is already in the token pool's control (locked). The releaseOrMint function may result in the pool conducting a transfer call to receiver. In various exemplary embodiments, a wrapped token pool may control a token which is not native to its chain (e.g., LINK on Avalanche). The system 100 may determine whether to burn a specified amount of a token or mint a specified amount of a token and release the token to the receiver. The function LockOrBurn may result in burning the specified amount of a token. The function releaseOrMint results in the pool minting the specified amount to receiver. The Token Pool architecture allows the system to be flexible regarding the token handling logic without affecting the core CCIP protocol.

In various exemplary embodiments, the system may comprise billing models. The billing models may include the fee token. As mentioned, the sender of a message may include a fee token in the cross-chain message. For example, the fee token may be included using the (feeToken) field in the cross-chain message. In various exemplary embodiments, the source chain 110 may comprise a relaying fee and an execution fee is collected directly from the fee token specified on the source chain 110. In various exemplary embodiments, the fee token may further comprise basis points. In various exemplary embodiments, the basis points may include the liquidity required for L/U tokens.

In various exemplary embodiments, the cross-chain interoperability system 100 may send cross-chain messages from a source chain 110 to a destination chain 150 using a router interface. The router interface of the source blockchain may comprise router 114. The router interface may comprise a receiver address, data, token amount, fee token, a destination chain 150, a message and/or other data or information mentioned herein. The sender 112 may use, for example, the router interface to send a cross-chain message. The router interface may interact with smart contracts on the source chain 110. The router interface, or IRouter may comprise the following data field: {struct EVM2AnyMessage {bytes receiver; bytes data; EVMTokenAmount [ ] tokenAmounts; address feeToken; bytes extraArgs;} struct EVMTokenAmount {address token; unit256 amount;} function ccipSend (unit64 destinationChainId, Client.EVM2AnyMessage memory message) external payable returns (bytes32) { }.

In various exemplary embodiments, the cross-chain interoperability system 100 may comprise a message receiver interface. The message receiver interface may be implemented with the destination chain 150 in order to be able to receive messages from the source chain 110. For example, the message receiver interface may be used to allow the destination chain 150 to receive cross-chain messages. The message receiver interface, or MessageReciever may comprise the following data field: interface IAny2EVMMessageReceiver{struct Any2EVMMessage{bytes32messageId; uint64 sourceChainId; bytes sender; bytes data; EVMTokenAmount[ ]destTokenAmounts;} struct EVMTokenAmount {address token; unit256 amount;}. The router interface may call the message receiver interface to deliver a cross-chain message. For example, the router interface may call the following function to deliver a cross-chain message to the message receiver interface: function ccipReceive (Client.Any2EVMMessage calldata message) external. In various exemplary embodiments, the message reviever interface may comprise the offramp 160 and/or router 158. It can be appreciated that the offramp 160 and/or router 158 may be implemented together or separate. It can also be appreciated, that the destination blockchain 150 may comprise either an offramp 160, a router 158, or both modules. The CCIP 100 may be configured to be operable with various destination chains 150 with various message receivers and/or router interfaces.

In various exemplary embodiments, the cross-chain interoperability system 100 may comprise safety mechanisms. For example, the system 100 may comprise an off-chain reporting protocol, such as OCR2. The system 100 may use an off-chain reporting protocol for the operation of DON and transfer of information between the source chain 110 and the destination chain 150. The cross-chain interoperability system 100 may comprise rate limiting functions or components. The system may rate limit the tokens by determining whether a threshold rate of tokens are transferred. For example, OnRamps and OffRamps may be used to ensure that only a predictable flow of tokens may cross the chain. Rate limiting may allow the system to limit impact in case of safety problems and gives the system time to react when security threats arise.

In various exemplary embodiments, the system 100 may determine whether a cross-chain message has failed to be delivered to a destination chain 150. For example, the system may determine not enough funds are included. The system 100 may mark as underfunded; consequently, in order to reprocess this transaction a user will have to send a retry call. The system may determine chain connection issues and whether a blockchain is down or inactive. The system may determine if a cross-chain message disappears on a destination chain 150 or on a source chain 110 and reorganize in response. The system may address unforeseen bugs. If the system 100 determines the cross-chain message has failed to send to the destination chain 150, a user may re-request the transaction on the source chain 110. In various exemplary embodiments, the system 100 may retry to send the transaction where a transfer of a cross-chain message has failed. The system may determine whether to retry the transfer based on if the user is marked as whitelisted, no or blocked, or anyone.

In various exemplary embodiments, the system 100 may be configured to deploy a contract on the source chain 100, such as OnRamp 116. In various exemplary embodiments, the system 100 may deploy one or more contracts on the destination chain 150, such as OffRamp 160 and/or Commit Store. In various exemplary embodiments, an OCR plugin may read from the source chain 110 and write to the destination chain 150. In various exemplary embodiments, the OCR plugin may be implemented on the CCIP 200 and configured to read and/or write with the source chain 110 and/or destination chain 150.

In various exemplary embodiments, the system 100 may comprise a home chain, wherein the home chain comprises a home chain contract for configuring the communication from a source chain 110 to a destination chain 150. The system 100 may comprise node operators (NOPs). The source chain 110 and destination chain 150 may work with NOPs to read and write data. The NOPs may be part of the CCIP 200, one or more DONs, or other distributed computer systems of the system 100, as described herein. In various exemplary embodiments, a home chain contract may comprise configuration data readable by NOPs. In various exemplary embodiments, the home chain contract may comprise configuration data regarding which NOPs support which blockchains and define an “f” threshold per source chain (generally n=3f+1). The home chain may be stored on a non-chain location. In various exemplary embodiments, the system 100 may comprise gathering agreement from the threshold of NOPs to support the chain, deploying contracts to that chain and configuring a set of NOPs (signers/transmitters) from 1, configuring the Registry contract with the set of NOPs from 1, and/or starting an Offchain OCR instance automatically based on 3, no new job specs required.

In various exemplary embodiments, the signers and transmitters set may be present on both the source chain 110 and destination chain 150, such that the OCR instance may verify signatures from participating nodes off-chain 170 and the receiving contract can similarly verify signatures off chain 170. For example, the CCIP 200 may comprise one or more nodes configured to verify the signatures associated with a cross-chain message off-chain 170, such as by a home chin contract, for example. In various exemplary embodiments, each blockchain may comprise a distinct transmitter key, wherein the transmitter key is specific to a particular blockchain. In various exemplary embodiments, the NOPs may create, fund and manage transmitter keys for the chains it supports. In various exemplary embodiments, the OCR may be configured to sign public keys on chain, wherein the signatures produced from the NOPs are verified on the remote chains. In various exemplary embodiments, the NOPs may be configured to sign for all blockchains. In various exemplary embodiments, each of the NOPs may be configured to sign for a particular blockchain and may each create the key bundle automatically.

In various exemplary embodiments, the system 100 may re-use OCR keybundles across-chains. Accordingly, the NOPs of CCIP 200 may create a keybundle for a chain and the system 100 may be configured to reuse that keybundle. In various exemplary embodiments, a keybundle may be a key for cryptographically verifying a cross-chain message or transaction. In various exemplary embodiments, the NOPs may create a distinct onchain signing key for a particular chain for optimizations onchain when verifying such signatures. In this case, each of the NOPs may create an OCR keybundle for that chain even if the NOP does not support the chain, such that the NOP may still be configured to contribute observations from the chains they do support and verify the observations onchain.

In various exemplary embodiments, the system 100 may comprise a CCIP 200 configured to work with various blockchains, including permissionless blockchains, permissioned blockchains, and various ledgers, such as banking oriented legers.

Exemplary benefits of the systems and methods described herein are lower operational costs and minimizing per-message transaction costs. This is achieved by reducing the number of transactions and external off chain devices required to send, validate and record a cross-chain message. Further, an additional benefit of the systems and methods described herein is added security, through the use of the CCIP 200, the CCIP may communicate directly with the source blockchain 110 and organize the verification of the cross-chain message and recording of the cross-chain message without the same risks typically associated with communicating across blockchains. Another benefit of the systems and methods herein is the ability to easily scale to new blockchains.

In various exemplary embodiments, the system 100 may use trusted 3rd party RPCs and Trusted Execution Environments (TEEs) in addition to 1^{st} party RPC nodes. In various exemplary embodiments, the system 100 may utilize 1^{st} party RPC nodes, wherein all of the nodes are directly managed by the CCIP 200 infrastructure. However, in various exemplary embodiments, the CCIP 200 and system 100 may utilize 3^{rd} Party RPC nodes, 3^{rd}-party RPC providers, RPC connection topologies, and technologies like TEEs.

In various exemplary embodiments, the system 100 may be considered to utilize nodes with a specific fault tolerance parameter f, for each chain, wherein the fault tolerance specifies the maximum number of byzantine failures the system 100 can tolerate. In various exemplary embodiments, where each OCR instance services a single directional lane, the parameter f may coincide with the fault tolerance parameter of the OCR instance itself. In various exemplary embodiments, wherein each OCR instance services all inbound lanes to a single destination chain, the parameter f is chain specific, and can differ from the fault tolerance parameter of the OCR instance itself. In various exemplary embodiments, the CCIP owner may select a group of NOPs that support reading from and writing to each chain. In various exemplary embodiments, the group of NOPs may coincide with the group of NOPs that operate the OCR instance. In various exemplary embodiments, the group of NOPs may be a subset of the group of NOPs that operate the OCR instance.

In various exemplary embodiments, the number of NOPs in the chain's group must be at least 3f+1 to ensure both safety and liveness. In various exemplary embodiments, each nop supporting a chain may run a dedicated full node for that chain to read blockchain data, and write transactions. In various exemplary embodiments, however, the number of NOPs running 1st-party RPC can actually be lower than the typical value of 3f+1. For example, the system 100 may utilize TEE, wherein the number of NOPs can be reduced to f+1.

In various exemplary embodiments, 2f+1 NOPs operate 1st-party RPCs and provide CCIP-related blockchain data to oracles running on the same hosts. In various exemplary embodiments, the leader waits to receive at least f+1 consistent (=equal) observations and uses them to form the proposal. Relying on (pre-)agreement on the CCIP-related data provided by the blockchain to be monitored, and assuming that at most fNOPs are byzantine, selecting 2f+1/NOPs to run RPCs ensure that f+1 of the NOPs are honest and thus can provide the required consistent observations.

In various exemplary embodiments, the NOPs may be mapped to RPC providers in various manners. For example, each NOP may be mapped to every available RPC provider (“All-All Mapping”). In various exemplary embodiments, each NOP may be mapped to its own dedicated RPC provider (“1 to 1 Mapping”). In various exemplary embodiments, each NOP may connect to its own dedicated set of RPC providers (“1-Many Mapping”). In various exemplary embodiments, multiple NOPs may be mapped to share a single 3^{rd} party RPC provider (“Many-1 Mapping”). In various exemplary embodiments, each NOP is connected to a subset of all 3^{rd} party RPC providers and each of the RPC providers is mapped to a subset of NOPs (“Many-Many Mapping”). In Many-to-Many mapping, multiple NOPs may be connected to multiple RPC providers, and/or multiple RPC providers may be mapped to multiple NOPS. For example, each NOP may be mapped to one or more RPC providers.

In various exemplary embodiments, the user 1 may send a cross-chain message on the source chain 110. The committing DON 130 may observe the cross-chain message on the source chain 110 and produce a report containing the cross-chain message and write the cross-chain message on the destination chain 150. The execution don 140 may observe the cross-chain message that was committed and attempts to execute the message once conditions are favorable, such as when fees are sufficient.

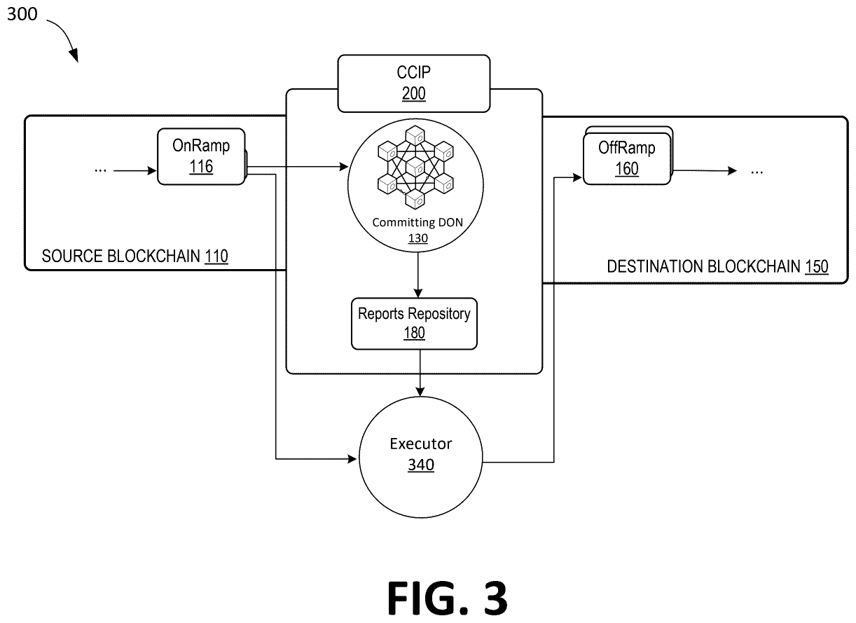

With reference to FIG. 3, a system 300, wherein the CCIP 200 further comprises a reports repository 180 is shown in accordance with various embodiments. In various exemplary embodiments, the CCIP 200 may only read from the source chain 110 rather than write to the source chain 110. In various exemplary embodiments, the commit DON 130 may produce a report containing the cross-chain message and send the report to the Reports Repository 180 of CCIP 200. In various exemplary embodiments, an executor 340 may observe the cross-chain message that was committed to the reports repository 180 and execute the cross-chain message on the destination chain 150. In various exemplary embodiments, the executor 340 may be external to CCIP 200. In various exemplary embodiments, executor 340 may receive revenue for verification and execution of the cross-chain message. In various exemplary embodiments, the CCIP 200 may be similar to Execution DON 140 as described with reference to FIG. 2, however only one executor 340 may be needed to verify and execute a transaction. In various exemplary embodiments, the user 1 may also act as the executor 340. In various exemplary embodiments, the executor 340 may be a separate executor 340 that is not the user 1.

In various exemplary embodiments, multiple blockchains may be able to interact using CCIP 200. For example, CCIP 200 and systems 100 and 300 may be used to send and execute a cross-chain message between various blockchains and families of chains, such as Ethereum, Solana, Sui, Aptos, Cosmos. It can be appreciated that various blockchains and families of chains may comprise different address, formats, payment systems, router and onramp and off ramp structures. In various exemplary embodiments, CCIP 200 may be configured to read and write cross-chain messages across various blockchains and families of blockchains. As mentioned previously, the CCIP may comprise a home chain or other storage comprising information regarding different blockchains.

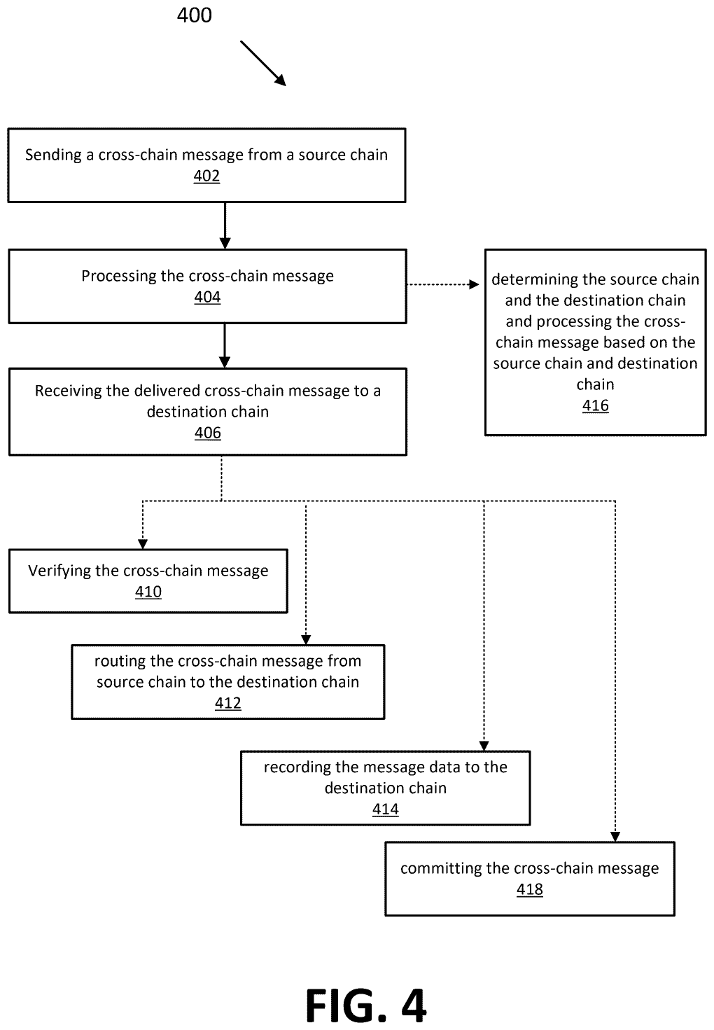

With reference now to FIG. 4, in various exemplary embodiments, a method for cross-chain interoperability 400 may be implemented, for example with the systems, devices and methods as shown in FIGS. 1-3. The method 400 includes sending, e.g. by a sender, a cross-chain message from a source chain (step 402). The cross-chain message may comprise a receiver address, and a message data. The method 400 may include processing, e.g. by a cross-chain processing system, the cross-chain message. (step 404) The method 400 may further comprise receiving, e.g. by a receiver corresponding with the receiver address, the delivered cross-chain message to a destination chain (step 406). The delivered cross-chain message may comprise the message.

In various exemplary embodiments, the method 400 may optionally include verifying, e.g. by the cross-chain processing system, the cross-chain message (step 410). The method 400 may optionally include routing, e.g. by a router on the source chain, the cross-chain message from source chain to the destination chain (step 412). The method 400 may optionally include recording, e.g. by the cross-chain processing system, the message data to the destination chain (step 414). The processing the cross-chain message (step 404) may further comprise determining the source chain and the destination chain and processing the cross-chain message based on the source chain and destination chain (step 416). The method 400 may optionally include committing, e.g. by a committing decentralized oracle network (DON) of the cross-chain processing system, the cross-chain message (step 418).

In addition to all the foregoing, principles of the present disclosure may be compatible with, complimentary to, and/or utilized in connection with principles set forth in:
U.S. Ser. No. 16/553,292 filed Aug. 28, 2019, now U.S. Pat. No. 11,854,101 entitled “Systems, Methods, and Storage Media for Interfacing At Least One Smart Contract Stored on A Decentralized Architecture With External Data Sources;”
U.S. Ser. No. 17/471,035 filed on Sep. 9, 2021, entitled “Computer Network Transaction Sequencing Method and System;”
U.S. Ser. No. 17/678,769 filed on Feb. 23, 2022, now U.S. Pat. No. 12,074,853 entitled “Method and Apparatus for Providing Secure Information to a Decentralized Computing Environment;” and.
U.S. Ser. No. 18/207,888 filed on Jun. 9, 2023, now U.S. Patent Application Publication No. 2023-0318857 entitled “Method and Apparatus for Producing Verifiable Randomness Within a Decentralized Computing Network.”

The contents of each of the foregoing applications and patents are incorporated herein by reference, but except for any subject matter disclaimers or disavowals, and except to the extent that the incorporated material is inconsistent with the express disclosure herein, in which case the language in this disclosure shall control.

For the sake of brevity, conventional database management, network communication, computer networking, data compression, error checking, and other aspects of exemplary systems and methods (and components thereof) may not be described in detail herein. Furthermore, the connecting lines shown in the various figures contained herein are intended to represent functional relationships and/or physical or communicative couplings between the various elements. It should be noted that many alternative or additional functional relationships or physical connections may be present in a practical system of consensus or related methods.

While the description references specific technologies, system architectures and data management techniques, practitioners will appreciate that this description is of various exemplary embodiments, and that other devices and/or methods may be implemented without departing from the scope of principles of the present disclosure.

While the steps outlined herein represent exemplary embodiments of principles of the present disclosure, practitioners will appreciate that there are many suitable computing algorithms and user interfaces that may be applied to create similar results. The steps are presented for the sake of explanation only and are not intended to limit the scope of the present disclosure in any way. Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all of the claims.

Systems, methods, and computer program products are provided. In the detailed description herein, references to “various exemplary embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement principles of the disclosure in alternative embodiments.

For example, the steps recited in any of the method or process descriptions may be executed in any suitable order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. An individual component may be comprised of two or more smaller components that may provide a similar functionality as the individual component. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Use of ‘a’ or ‘an’ before a noun naming an object shall indicate that the phrase be construed to mean ‘one or more’ unless the context sufficiently indicates otherwise, as set forth in Slip op. at 8-9 (Fed. Cir. Oct. 19, 2023) (citing Baldwin Graphic Sys., Inc. v. Siebert, Inc., 512 F .3d 1338, 1342-43 (Fed. Cir. 2008)). For example, the description or claims may refer to a processor for convenience, but principles of the disclosure contemplate that the processor may be multiple processors. The multiple processors may handle separate tasks or combine to handle certain tasks. Although specific advantages have been enumerated herein, various exemplary embodiments may include some, none, or all of the enumerated advantages. A “processor” may include hardware that runs the computer program code. Specifically, the term ‘processor’ may be synonymous with terms like controller and computer and should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices.

It should be understood that the detailed description and specific examples, indicating exemplary embodiments, are given for purposes of illustration only and not as limitations. Many changes and modifications may be made without departing from the spirit thereof, and principles of the present disclosure include all such modifications. Corresponding structures, materials, acts, and equivalents of all elements are intended to include any structure, material, or acts for performing the functions in combination with other elements. Reference to an element in the singular is not intended to mean “one and only one” unless explicitly so stated, but rather “one or more.” Moreover, when a phrase similar to “at least one of A, B, or C” or “at least one of A, B, and C” is used in the claims or the specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A cross-chain interoperability device, comprising:
one or more processors configured by machine-readable instructions to:
send, by a sender, a cross-chain message from a source chain, the cross-chain message comprising a receiver address and a message data;
process, by a cross-chain processing system, the cross-chain message; and
receive, by a receiver corresponding with the receiver address, the delivered cross-chain message to a destination chain, the delivered cross-chain message comprising the message data.

2. The cross-chain interoperability device of claim 1, wherein the cross-chain processing system is an off-chain processing system comprising a Byzantine fault tolerant distributed protocol.

3. The cross-chain interoperability device of claim 1, wherein the cross-chain message is sent, by a router, from the source chain to the destination chain.

4. The cross-chain interoperability device of claim 1, wherein the cross-chain message further comprises a token.

5. The cross-chain interoperability device of claim 4, wherein the cross-chain message further comprises a fee token.

6. The cross-chain interoperability device of claim 5, wherein the cross-chain message further comprises metadata regarding processing of the message data.

7. The cross-chain interoperability device of claim 1, wherein the cross-chain processing system may correspond to the destination chain.

8. The cross-chain interoperability device of claim 1, wherein the cross-chain processing system may comprise a bridge comprising a router, a processing node, and a billing component.

9. The cross-chain interoperability device of claim 1, wherein the cross-chain processing system comprises a decentralized oracle network (DON), the DON comprising a committing DON for notifying the destination chain of cross-chain messages, and an execution DON for delivering the delivered cross-chain message to the receiver.

10. A method of cross-chain interoperability, the method comprising:
sending, by a sender, a cross-chain message from a source chain, wherein the cross-chain message comprises a receiver address and a message data;
processing, by a cross-chain processing system, the cross-chain message; and
receiving, by a receiver corresponding with the receiver address, the delivered cross-chain message to a destination chain, the delivered cross-chain message comprising the message data.

11. The method of cross-chain interoperability of claim 10, further comprising verifying, by the cross-chain processing system, the cross-chain message.

12. The method of cross-chain interoperability of claim 10, further comprising routing, by a router on the source chain, the cross-chain message from the source chain to the destination chain.

13. The method of cross-chain interoperability of claim 10, further comprising recording, by the cross-chain processing system, the message data to the destination chain.

14. The method of cross-chain interoperability of claim 10, wherein the processing the cross-chain message further comprises:
determining the source chain and the destination chain; and
processing the cross-chain message based on the source chain and destination chain.

15. The method of cross-chain interoperability of claim 10, further comprising committing, by a committing decentralized oracle network (DON) of the cross-chain processing system, the cross-chain message.

16. The method of cross-chain interoperability of claim 10, further comprising executing, by an execution DON, the cross-chain message on the destination chain.

17. A cross-chain interoperability system, comprising:
a processor; and
a tangible, non-transitory memory configured to communicate with the processor, the tangible, non-transitory memory having instructions stored thereon that, in response to execution by the processor, cause the processor to perform operations comprising:
sending, by a sender, a cross-chain message from a source chain, the cross-chain message comprising a receiver address and a message data;
processing, by a cross-chain processing system, the cross-chain message; and
receiving, by a receiver corresponding with the receiver address, the delivered cross-chain message to a destination chain, the delivered cross-chain message comprising the message data.

18. The cross-chain interoperability system of claim 17, wherein the cross-chain processing system is an off-chain processing system comprising a Byzantine fault tolerant distributed protocol.

19. The cross-chain interoperability system of claim 17, wherein the cross-chain message is sent, by a router, from the source chain to the destination chain.

20. The cross-chain interoperability system of claim 17, wherein the cross-chain message further comprises a token, a fee token, and metadata regarding processing of the message data.

21. The cross-chain interoperability system of claim 17, wherein the cross-chain processing system may correspond to the destination chain.

22. The cross-chain interoperability system of claim 17, wherein the cross-chain processing system may comprise a bridge comprising a processing node, and a billing component.
